(19) United States
(12) Patent Application Publication
(10) Pub. No.: US 2007/0062779 A1
(43) Pub. Date: Mar. 22, 2007

(54) Parking lock mechanism of automatic transmission

(75) Inventors: Daisuke Kusamoto, Nagoya-shi (JP); Yuji Yasuda, Nishikamo-gun (JP); Terufumi Miyazaki, Toyota-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/501,710

(22) Filed: Aug. 10, 2006

(30) Foreign Application Priority Data
Sep. 21, 2005 (JP) 2005-274305

(51) Int. Cl. B60W 10/10

(52) U.S. Cl. 192/219.5

(57) ABSTRACT

A parking lock mechanism of an automatic transmission includes a parking gear provided in a casing, a parking pawl engaged with the parking gear to achieve a parking lock state, a parking rod moving in an axial direction to press the parking pawl against the parking gear, and a guide portion guiding movement of the parking rod in the axial direction. The guide portion is formed with a casing.

This nonprovisional application is based on Japanese Patent Application No. 2005-274305 filed with the Japan Patent Office on Sep. 21, 2005, the entire contents of which are hereby incorporated by reference.

### FIELD OF THE INVENTION

The present invention relates to a parking lock mechanism of an automatic transmission, and more particularly to a parking lock mechanism of an automatic transmission having a guide portion guiding movement of a parking rod in an axial direction.

### DESCRIPTION OF THE BACKGROUND ART

A parking lock mechanism of an automatic transmission has conventionally been known.

For example, Japanese Patent Laying-Open No. 07-144616 (Patent Document 1) discloses a parking lock device achieving a park lock state by causing a parking pawl to pivot toward a parking gear such that a pawl at the tip end is engaged with a tooth of the parking gear. Here, a guide for guiding a cam fitted with looseness onto a parking rod is provided in a transmission case.

The parking lock mechanism as described above is provided in a casing such as a transmission case.

In the parking lock mechanism of the automatic transmission, the guide portion for guiding movement of the parking rod in the axial direction is provided. Separately providing a guide member for implementing the guide portion, however, leads to increase in the number of parts. In addition, if a space for placing the guide member is provided in a casing, a volume of the casing and hence the weight of the automatic transmission is increased.

According to Patent Document 1, the guide for guiding movement of the parking rod is provided in the transmission case, however, the guide and the case are again provided as members separate from each other.

Meanwhile, from a viewpoint different from above, relatively large load is imposed on an inclined surface which extends in a direction intersecting the axial direction of the parking rod and slides with respect to the cam of the rod. Accordingly, if the inclined surface is formed with the casing, durability of the casing may be lowered. Meanwhile, in order to ensure a parking lock state, an accurately formed inclined surface is demanded.

### SUMMARY OF THE INVENTION

An object of the present invention is to provide a parking lock mechanism of an automatic transmission capable of achieving smaller number of parts and weight. Another object of the present invention is to achieve an effect to reduce the number of parts and weight while maintaining high durability of a casing and high accuracy of an inclined surface in the parking lock mechanism of the automatic transmission.

A parking lock mechanism of an automatic transmission according to the present invention includes: a casing; a parking gear provided within the casing; a parking pawl engaged with the parking gear to achieve a parking lock state; a parking rod pressing the parking pawl against the parking gear while moving in an axial direction; and a guide portion guiding movement of the parking rod in the axial direction. The guide portion is formed with the casing.

According to the structure above, as the guide portion is formed with the casing, it is not necessary to separately provide a member for implementing the guide portion. Therefore, the number of parts can be reduced. In addition, as a space for placing the member is not necessary and a volume of the casing can be reduced, the weight of the automatic transmission can be reduced.

Preferably, the parking lock mechanism of an automatic transmission further includes a sleeve member having an inclined surface that extends in a direction intersecting the axial direction of the parking rod and slides with respect to the parking rod moving in the axial direction.

According to the structure above, as the inclined surface receiving relatively large load is formed with a member separate from the casing, lowering in durability of the casing can be suppressed and the inclined surface can be formed with high accuracy.

In the parking lock mechanism of the automatic transmission, preferably, a member fixing the sleeve member is inserted in the casing located in the vicinity of the guide portion.

According to the structure above, as a portion for implementing the guide portion in the casing can also serve as a portion in which the fixing member is inserted, the casing can be reduced in size. Consequently, the weight of the automatic transmission can be reduced.

In the parking lock mechanism of the automatic transmission, preferably, the sleeve member is formed by sintering powders containing a metal.

In this manner, the sleeve member attaining high strength can be formed with high accuracy.

According to the present invention, the number of parts and the weight of an automatic transmission can be reduced as described above.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a structure of a parking lock mechanism of an automatic transmission according to one embodiment of the present invention.

FIG. 2 shows the parking lock mechanism shown in FIG. 1 in further detail.

FIG. 3 is a cross-sectional view along the line III-III in FIG. 2.

### DESCRIPTION OF THE PREFERRED EMBODIMENTS

An embodiment of a parking lock mechanism of an automatic transmission according to the present invention will be described hereinafter. The same or corresponding elements have the same reference characters allotted, and detailed description thereof may not be repeated.

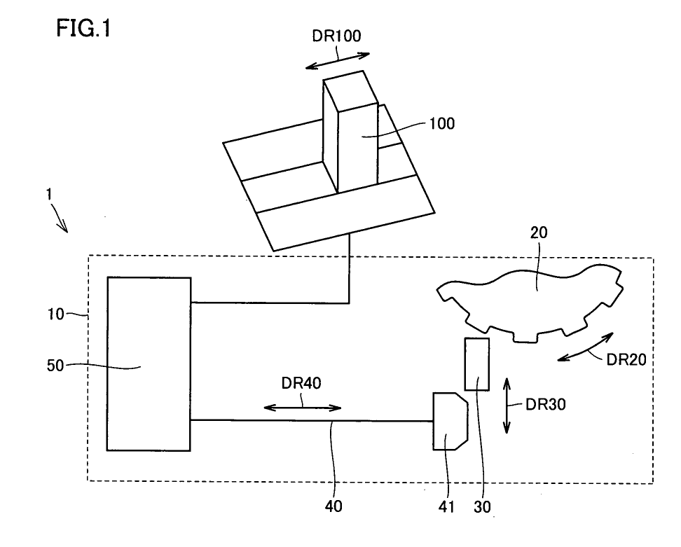

FIG. 1 shows a structure of a parking lock mechanism of an automatic transmission according to one embodiment of the present invention. Referring to FIG. 1, a parking lock mechanism 1 includes a parking gear 20 provided in a casing 10 (such as a transmission case), a parking pawl 30, a parking rod 40, and a transmission mechanism 50.

Parking gear 20 is connected to an output shaft of a powertrain of a vehicle and rotates in a direction of arrow DR20 when the vehicle runs. When parking gear 20 is engaged with parking pawl 30, the output shaft connected to a drive shaft of the vehicle is fixed. A parking lock state is thus achieved.

Parking rod 40 is connected to a selector lever 100 selecting a gear shift state through transmission mechanism 50. When selector lever 100 is moved in a direction of arrow DR100, a parking position, a reverse position, a neutral position, or a forward drive position is selected. When the parking position is selected by means of selector lever 100, parking rod 40 moves in a direction of arrow DR40. Then, a cam 41 provided in parking rod 40 moves parking pawl 30 in a direction of arrow DR30. Namely, parking pawl 30 is pressed against parking gear 20. Parking pawl 30 and parking gear 20 are thus engaged with each other.

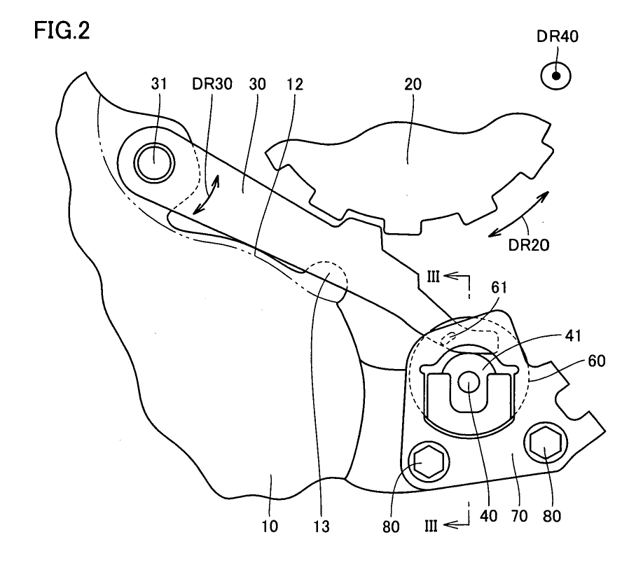

FIG. 2 shows the parking lock mechanism shown in FIG. 1 in further detail. As shown in FIG. 2, a pivot support portion 31 is provided on one end side of parking pawl 30. Parking pawl 30 is supported by pivot support portion 31 in a manner pivotable with respect to casing 10 in a direction of arrow DR30. The other end side of parking pawl 30 is in contact with cam 41 provided in parking rod 40. Cam 41 is in contact with a sleeve 60. A protruding portion 61 protruding from the front to the rear of the sheet showing FIG. 2 is provided in sleeve 60. Protruding portion 61 comes in contact with parking pawl 30. Sleeve 60 is fixed to casing 10 by a retainer plate 70 and a bolt 80.

A groove portion 12 and a base 13 are provided in casing 10. Base 13 supports parking pawl 30 from the rear toward the front of the sheet showing FIG. 2. On the other hand, protruding portion 61 provided in sleeve 60 supports parking pawl 30 from the front to the rear of the sheet showing FIG. 2. Inclination of parking pawl 30 in direction of arrow DR40 is thus suppressed.

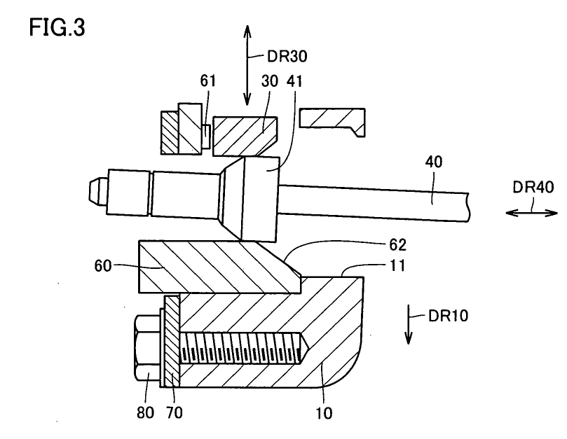

FIG. 3 is a cross-sectional view along the line III-III in FIG. 2. Referring to FIG. 3, a guide portion 11 along the axial direction (direction of arrow DR40) of parking rod 40 is formed in casing 10. Guide portion 11 guides movement of cam 41 in a direction of arrow DR40 when a parking lock operation is performed, so that parking rod 40 can smoothly move. Sleeve 60 is fitted in a hole provided in casing 10. Here, sleeve 60 is provided at a position adjacent to guide portion 11 in casing 10. Sleeve 60 has an inclined surface 62 at a position adjacent to guide portion 11. Inclined surface 62 extends in a direction inclined obliquely with respect to the axial direction of parking rod 40. When the parking lock operation is performed, cam 41 that has passed over guide portion 11 slides with respect to inclined surface 62, so that cam 41 moves toward parking pawl 30 and presses parking pawl 30. Consequently, parking pawl 30 pivots in a direction of arrow DR30, and parking pawl 30 is engaged with parking gear 20. As shown in FIG. 3, movement of sleeve 60 in a direction of arrow DR40 is restricted by retainer plate 70 and bolt 80.

In the following, guide portion 11 and sleeve 60 will be described in further detail.

Casing 10 implementing guide portion 11 is formed, for example, from aluminum. Aluminum is employed to achieve lighter weight of the automatic transmission. When casing 10 is fabricated, a mold is removed in a direction of arrow DR10. Casing 10 having a certain volume is present on a downstream side of guide portion 11 in a direction of removal of the mold (direction of arrow DR10). In parking lock mechanism 1 according to the present embodiment, a bolt insertion hole is provided in casing 10 located in this portion. In other words, bolt 80 is inserted in the vicinity of guide portion 11. In addition, bolt 80 is inserted in casing 10 such that guide portion 11 and sleeve 60 adjacent thereto are aligned with bolt 80 in the direction of arrow DR10. Bolt 80 is inserted in a direction in which guide portion 11 and sleeve 60 are aligned. In this manner, a portion formed by providing guide portion 11 can effectively be utilized to suppress excessive increase in weight of casing 10.

When parking rod 40 moves, sleeve 60 having inclined surface 62 receives load larger than that to guide portion 11. Therefore, desirably, sleeve 60 having high strength is manufactured. In addition, for ensured operation of parking lock mechanism 1, sleeve 60 is desirably manufactured with high accuracy. In the present embodiment, sleeve 60 is formed, for example, from an iron-based sintered metal. Cam 41 is manufactured, for example, through cutting process of an iron-based material, while parking pawl 30 is manufactured, for example, through high-precision press working of an iron-based material.

Summarizing the description above, parking lock mechanism 1 of the automatic transmission according to the present embodiment includes casing 10, parking gear 20 provided in casing 10, parking pawl 30 engaged with parking gear 20 to achieve a parking lock state, parking rod 40 pressing parking pawl 30 against parking gear 20 while moving in the axial direction, and guide portion 11 guiding movement of parking rod 40 in the axial direction. Guide portion 11 is formed with casing 10.

As described above, guide portion 11 is formed by utilizing a shape of casing 10, and it is not necessary to separately provide a guide member for implementing guide portion 11. Therefore, the number of parts of parking lock mechanism 1 can be reduced. In addition, as a space for placing the guide member is not necessary, a volume of casing 10 can be reduced. Consequently, the weight of the automatic transmission can be reduced.

Parking lock mechanism 1 further includes sleeve 60 serving as the “sleeve member” having inclined surface 62 that extends in a direction obliquely intersecting the axial direction (direction of arrow DR40) of parking rod 40 and slides with respect to parking rod 40 moving in the direction of arrow DR40.

When parking rod 40 moves in the direction of arrow DR40, relatively large load is imposed on inclined surface 62. Inclined surface 62 is implemented by a member separate from casing 10 as described above, thereby suppressing lowering in durability of casing 10.

In parking lock mechanism 1, bolt 80 serving as the “means for fixing” sleeve 60 is inserted in the portion in the vicinity of guide portion 11 in casing 10.

In this manner, casing 10 is reduced in size and the weight of the automatic transmission is decreased. It is noted that the “means for fixing” is not limited to bolt 80, and for example, a pin may be employed.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A parking lock mechanism of an automatic transmission, comprising:
a casing;
a parking gear provided within said casing;
a parking pawl engaged with said parking gear to achieve a parking lock state;
a parking rod pressing said parking pawl against said parking gear while moving in an axial direction; and
a guide portion guiding movement of said parking rod in the axial direction; wherein
said guide portion is formed with said casing.

2. The parking lock mechanism of an automatic transmission according to claim 1, further comprising a sleeve member having an inclined surface that extends in a direction intersecting the axial direction of said parking rod and slides with respect to said parking rod moving in the axial direction.

3. The parking lock mechanism of an automatic transmission according to claim 2, wherein
means for fixing said sleeve member is inserted in said casing located in vicinity of said guide portion.

4. The parking lock mechanism of an automatic transmission according to claim 2, wherein
a member fixing said sleeve member is inserted in said casing located in vicinity of said guide portion.

5. The parking lock mechanism of an automatic transmission according to claim 2, wherein
said sleeve member is formed by sintering powders containing a metal.
